(19) United States
(12) Patent Application Publication
(10) Pub. No.: US 2020/0166113 A1
(43) Pub. Date: May 28, 2020

(54) SPROCKET WITH ELASTOMER CUSHION RING

(71) Applicant: BorgWarner Inc., Auburn Hills, MI (US)

(72) Inventors: Adam T. HOLIC, Dryden, NY (US); Bradley F. ADAMS, Homer, NY (US); Robert G. WILLIAMSON, Breesport, NY (US)

(21) Appl. No.: 16/613,842

(22) PCT Filed: May 17, 2017
(86) PCT No.: PCT/US2017/033098

§ 371 Date: Nov. 15, 2019

(51) Int. Cl. F16H 55/30; F16H 7/06

(52) U.S. Cl. CPC F16H 55/30; F16H 2055/306; F16H 7/06

(57) ABSTRACT

In one form, the present disclosure provides for a sprocket assembly including a sprocket wheel and a sprocket cushion. The sprocket wheel can include teeth extending radially outward from a hub. The cushion can be coupled to the hub on a first axial side of the teeth. The cushion can include an annular base and a plurality of projections. The base can be disposed about the hub and the projections can extend radially outward therefrom. Each projection can include a first axial end, second axial end, top surface, and chamfer. The first axial end can be proximal to the first axial side of the teeth. The top surface can extend axially between the first axial end and the second axial end. The chamfer can join the second axial end and the top surface such that a radial thickness of each projection decreases with increased axial distance away from the teeth.

### FIELD

The present disclosure relates to a sprocket with an elastomer cushion ring.

### BACKGROUND

This section provides background information related to the present disclosure which is not necessarily prior art.

Vehicle valve trains, transmissions, drivelines, etc., often transmit torque via a sprocket and chain drive system. It is generally known to include a cushion (e.g., rubber or elastomer) on each side of the tooth row of the sprocket in order to dampen the chain upon engagement by reducing the impact force between the chain rollers (or bushings) and the sprocket. Sprocket cushion rings are typically sized to intentionally interfere with the chain as the chain engages the sprocket teeth. This process results in the chain links compressing and releasing the cushion ring as the chain engages and disengages the sprocket. Thus, sprocket cushion rings are potentially subjected to millions of load (i.e., compression) cycles over the useful life of the device in which they are employed. Despite the capability of rubber to withstand compression, displacement, and decompression, the rubber material still develops internal stress that can be detrimental to the life of the sprocket cushion and/or the chain. While typical sprocket cushion rings have been generally suitable for their particular uses, there exists room for improvement in the art.

### SUMMARY

This section provides a general summary of the disclosure, and is not a comprehensive disclosure of its full scope or all of its features.

In one form, the present disclosure provides for a sprocket assembly including a sprocket wheel and a first sprocket cushion. The sprocket wheel can include a hub disposed about an axis and a plurality of teeth extending radially outward from the hub. The first sprocket cushion can be coupled to the hub on a first axial side of the teeth. The first sprocket cushion can include an annular base and a plurality of projections. The base can be disposed about the hub. The projections can extend radially outward from the base. Each projection can include a first axial end, a second axial end, a top surface, and a chamfer. The first axial end can be proximal to the first axial side of the teeth. The top surface can extend axially between the first axial end and the second axial end. The chamfer can join the second axial end and the top surface such that a radial thickness of each projection decreases with increased axial distance away from the teeth.

According to a further embodiment, a first fillet can tangently connect the top surface and the chamfer.

According to a further embodiment, a second fillet can tangently connect the chamfer and a first end face of the base.

According to a further embodiment, the first end face of the base can be perpendicular to the axis.

According to a further embodiment, each projection can be circumferentially spaced apart from an adjacent one of the projections by a corresponding one of a plurality of valleys. Each chamfer can extend radially inward of a radially inwardmost point of the corresponding one of the valleys.

According to a further embodiment, each projection can be circumferentially spaced apart from an adjacent one of the projections by a corresponding one of a plurality of valleys. Each valley can extend radially inward of a radially inwardmost point of a corresponding one of the chamfers.

According to a further embodiment, each projection can be circumferentially spaced apart from an adjacent one of the projections by a corresponding one of a plurality of valleys. Each valley can have a convex portion and a concave portion that meet at a transition region. The chamfer can extend radially inward of the transition region.

According to a further embodiment, the sprocket assembly can further include a second sprocket cushion coupled to the hub on a second axial side of the teeth.

According to a further embodiment, each tooth can be circumferentially spaced apart from an adjacent one of the teeth by a corresponding one of a plurality of tooth valleys. Each projection can be circumferentially spaced apart from an adjacent one of the projections by a corresponding one of a plurality of cushion valleys. Each cushion valley can align with one of the tooth valleys.

According to a further embodiment, the chamfer can define an angle relative to the axis. The angle can be between 15 degrees and 75 degrees.

In another form, the present disclosure provides for a sprocket assembly that can include a sprocket wheel and a first sprocket cushion. The sprocket wheel can include a hub disposed about an axis and a plurality of teeth extending radially outward from the hub. The first sprocket cushion can be coupled to the hub on a first axial side of the teeth. The first sprocket cushion can include an annular base and a plurality of projections. The base can be disposed about the hub. The projections can extend radially outward from the base. Each projection can include a first axial end, a second axial end, a top surface, and a fillet. The first axial end can be proximal to the first axial side of the teeth. The top surface can extend axially between the first axial end and the second axial end. The fillet can join the second axial end and the top surface. Each projection can be circumferentially spaced apart from an adjacent one of the projections by a corresponding one of a plurality of valleys. The fillet can meet the second axial end radially inward of half way between the top surface and a radially inwardmost point of the valley.

According to a further embodiment, each valley can have a convex portion and a concave portion that meet at a transition region. The fillet can meet the second axial end radially inward of the transition region.

According to a further embodiment, the fillet can tangently join the top surface and the second axial end.

According to a further embodiment, the fillet can have a radius of curvature that varies between the top surface and the second axial end.

In another form, the present disclosure provides for a sprocket assembly including a sprocket wheel, a first sprocket cushion, and a second sprocket cushion. The sprocket wheel can include a hub disposed about an axis and a plurality of teeth extending radially outward from the hub. The first sprocket cushion can be coupled to the hub on a first axial side of the teeth. The first sprocket cushion can include an annular first base and a plurality of first projections. The first base can be disposed about the hub. The first projections can extend radially outward from the first base. Each first projection can include a first axial end, a second axial end, a first radially outermost surface, and a first chamfer. The first axial end can be proximal to the first axial side of the teeth. The first radially outermost surface can extend axially between the first axial end and the second axial end. The first chamfer can join the second axial end and the first radially outermost surface such that a radial thickness of each first projection decreases in an axial direction away from the teeth. The second sprocket cushion can be coupled to the hub on a second axial side of the teeth. The second sprocket cushion can include an annular second base and a plurality of second projections. The second base can be disposed about the hub. The second projections can extend radially outward from the base. Each second projection can include a third axial end, a fourth axial end, a second radially outermost surface, and a second chamfer. The third axial end can be proximal to the second axial side of the teeth. The second radially outermost surface can extend axially between the third axial end and the fourth axial end. The second chamfer can join the fourth axial end and the second radially outermost surface such that a radial thickness of each second projection can decrease in an axial direction away from the teeth. A first fillet can tangently join the first radially outermost surface and the first chamfer. A second fillet can tangently join the first chamfer and the second axial end. Each first projection can be circumferentially spaced apart from an adjacent one of the first projections by a corresponding one of a plurality of first valleys. Each first chamfer can extend radially inward of a radially inwardmost point of the first valleys. A third fillet can tangently join the second radially outermost surface and the second chamfer. A fourth fillet can tangently join the second chamfer and the fourth axial end. Each second projection is circumferentially spaced apart from an adjacent one of the second projections by a corresponding one of a plurality of second valleys. Each second chamfer can extend radially inward of a radially inwardmost point of the second valleys.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a portion of a sprocket drive assembly, illustrating a sprocket, a pair of sprocket cushions, and a portion of a chain of a first construction in accordance with the present teachings;

FIG. 2 is a perspective view of a portion of the sprocket drive assembly of FIG. 1;

FIG. 3 is a top down view of a portion of the sprocket drive assembly of FIG. 1;

FIG. 4 is a sectional view of a portion of the sprocket drive assembly of FIG. 1, taken along line 4-4 shown in FIG. 1;

FIG. 5 is a sectional view of a portion of the sprocket drive assembly of FIG. 1, taken along line 5-5 shown in FIG. 1;

FIG. 6. is a sectional view similar to FIG. 5, illustrating compression of a typical sprocket cushion;

FIG. 7 is a perspective view similar to FIG. 2, illustrating a sprocket cushion of a second construction;

FIG. 8 is a perspective view similar to FIG. 2, illustrating a sprocket cushion of a third construction; and

FIG. 9 is a top down view similar to FIG. 3, illustrating the sprocket cushion of FIG. 8.

Corresponding reference numerals indicate corresponding parts throughout the several views of the drawings.

### DETAILED DESCRIPTION

Example embodiments will now be described more fully with reference to the accompanying drawings.

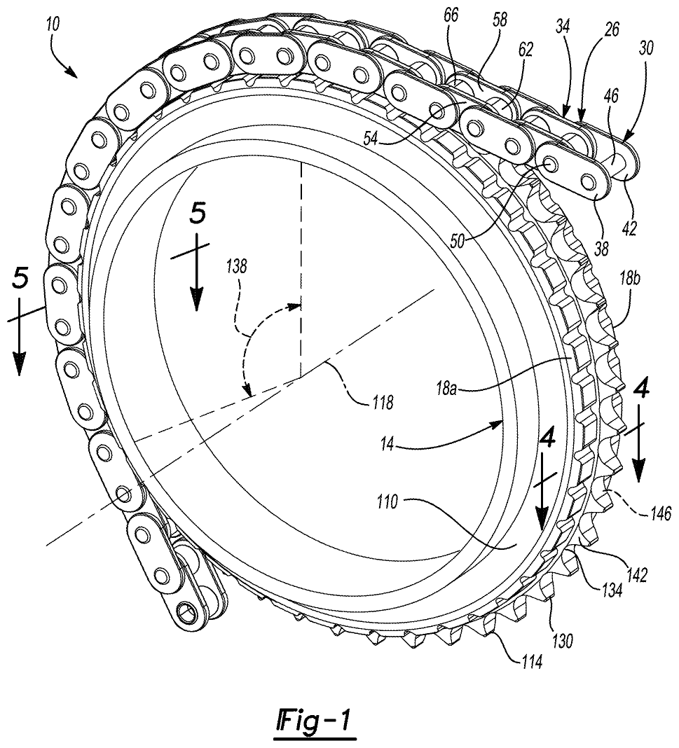

With reference to FIG. 1, a portion of a sprocket drive assembly 10 is illustrated, including a first sprocket wheel 14, a first sprocket cushion 18a, a second sprocket cushion 18b, and a chain 26. While only a portion of the chain 26 is illustrated in FIG. 1, the sprocket drive assembly 10 can include a second sprocket wheel (not shown) and additional sprocket cushions (not shown). The chain 26 can drivingly couple the first sprocket wheel 14 to the second sprocket (not shown) to transmit rotary power therebetween.

The chain 26 can be any suitable type of drive chain (e.g., a roller chain) and can generally include a plurality of first links 30 coupled together by a plurality of second links 34. In the example provided, each first link 30 can have a pair of first side plates 38, 42 coupled together by a pair of pins 46, 50 such that the first side plates 38, 42 are spaced apart from each other. Each second link 34 can have a pair of second side plates 54, 58 coupled together by a pair of cylinders 62, 66 such that the second side plates 54, 58 are spaced apart from each other. In the example provided, the first side plates 38, 42 are parallel to each other, the second side plates 54, 58 are parallel to each other and to the first side plates 38, 42, though other configurations can be used. Each pin 46, 50 can extend through a corresponding one of the cylinders 62, 66 of an adjacent one of the second links 34 to couple the first and second links 30, 34 together such that the first links 30 can pivot relative to the second links 34 about the pins 46, 50. Ends of each of the second side plates 54, 58 can be disposed between corresponding ends of the adjacent first side plates 38, 42 such that the first links 30 can be outer links and the second links 34 can be inner links.

The first sprocket wheel 14 can include a hub 110 and a plurality of teeth 114. The hub 110 can be an annular body disposed about an axis 118 about which the first sprocket wheel 14 can be configured to rotate. The hub 110 can have a first outer cylindrical surface 122 and a second outer cylindrical surface 126 (shown in FIG. 4) that can be coaxial with the first outer cylindrical surface 122 and the axis 118. The first and second outer cylindrical surfaces 122, 126 can face radially outward from the axis 118 and can have the same diameter. The first and second outer cylindrical surfaces 122, 126 can be axially spaced apart by the teeth 114.

The teeth 114 can be fixedly coupled to the hub 110 and can be equally spaced circumferentially about the hub 110. In the example provided, the teeth can be integrally formed with the hub 110. The teeth 114 can extend radially outward from the first and second outer cylindrical surfaces 122, 126 and be configured to engage the chain 26 at a first location in the circumferential direction of the first sprocket wheel 14 (e.g., a first location about the axis 118) and to disengage the chain 26 at a second location in the circumferential direction (e.g., at an angle about the axis 118 relative to the first location). In the example provided, the first sprocket wheel 14 can be configured to rotate about the axis 118 in both rotational directions such that the chain 26 can engage the first sprocket wheel 14 at the second location and disengage the first sprocket wheel 14 at the first location. Accordingly, the first and second locations can be referred to collectively herein as the engagement/disengagement locations.

Each tooth 114 can have a peak 130 which can be a radially outermost point of the tooth 114. The peak 130 can be pointed, flat, or rounded for example. Each tooth 114 can be separated from a circumferentially adjacent one of the teeth 114 by a valley 134. When the chain 26 is engaged with the first sprocket wheel 14, each peak 130 that is located in an azimuthal range 138 between the engagement/disengagement locations (i.e., within the angular range 138 between the engagement/disengagement locations relative to the axis 118) can be received in a corresponding space in the chain 26 between adjacent ones of the cylinders 62, 66. Each valley 134 within the azimuthal range 138 (i.e., angular range) between the engagement/disengagement locations can receive a corresponding one of the cylinders 62, 66. Thus, advancement of the chain 26 can cause a corresponding rotation of the first sprocket wheel 14 and/or rotation of the first sprocket wheel 14 can cause a corresponding advancement of the chain 26.

Within the azimuthal range 138 (i.e., angular range) between the engagement/disengagement locations, the first and second side plates 38, 42, 54, 58 can straddle the teeth 114 such that one of the first side plates 38 and one of the second side plates 54 are disposed on a first axial side 142 of the teeth 114. The other of the first side plates 42 and the other of the second side plates 58 can be disposed on the opposite axial side (i.e., a second axial side 146) of the teeth 114. Thus, the first and second side plates 38, 42, 54, 58 on the first axial side 142 can overlap in the axial direction with the first outer cylindrical surface 122 and be radially outward of the first outer cylindrical surface 122, while the first and second side plates 38, 42, 54, 58 on the second axial side 146 can overlap in the axial direction with the second outer cylindrical surface 126 (FIG. 4) and be radially outward of the second outer cylindrical surface 126.

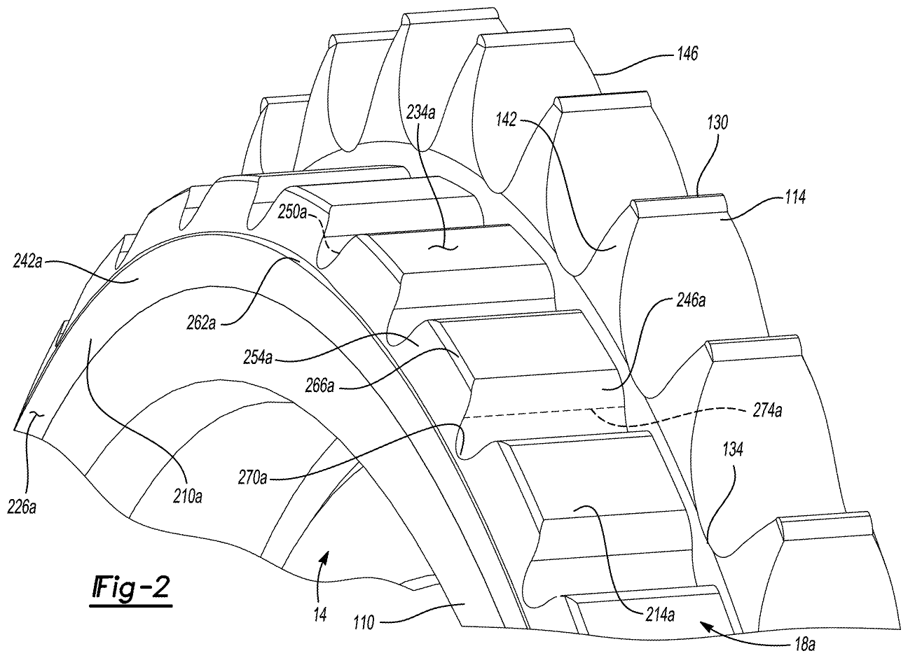

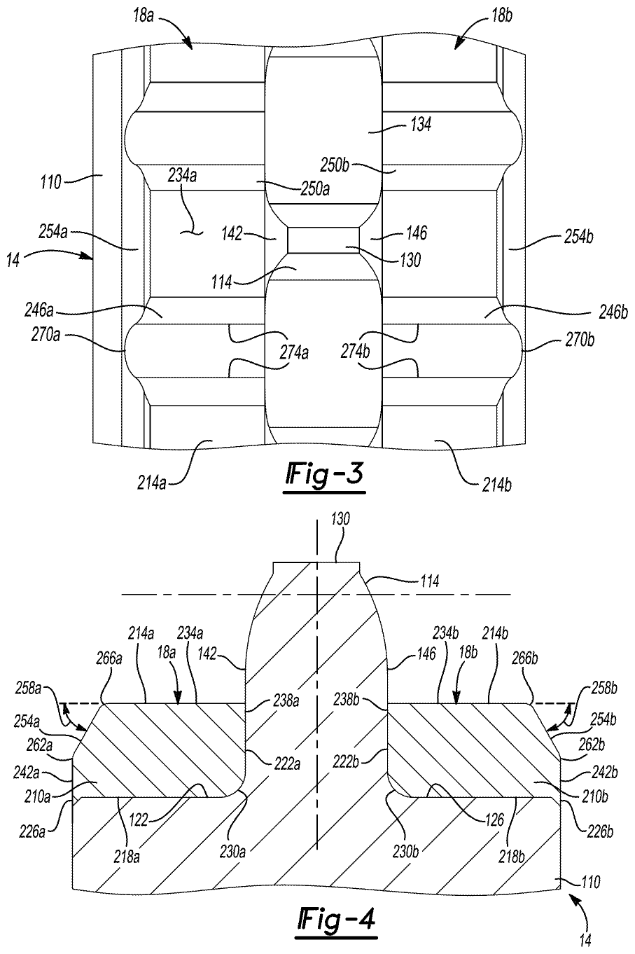

With additional reference to FIGS. 2-4, the first sprocket cushion 18a can include an annular base 210a and a plurality of projections 214a. In the example provided, the base 210a and the plurality of projections 214a are integrally formed from a resilient material, such as being a unitarily molded rubber or other elastomeric body. The base 210a can be disposed about the axis 118 and coupled to the hub 110 on the first axial side 142 of the teeth 114.

The base 210a can have an inner cylindrical surface 218a, a first end face 222a, and a second end face 226a. The inner cylindrical surface 218a can be coaxial with the axis 118 and can oppose and contact the first outer cylindrical surface 122 of the hub 110. The diameter of the inner cylindrical surface 218a can be less than or equal to the diameter of the first outer cylindrical surface 122, such that the first sprocket cushion 18a can be retained to the hub 110 by the radial resilience of the base 210a. The first and second end faces 222a, 226a can be generally transverse to the axis 118 and extend radially outward from the inner cylindrical surface 218a. The first end face 222a can oppose and contact the first axial side 142 of the teeth 114. In the example provided, the juncture between the inner cylindrical surface 218a and the first end face 222a can include an exterior fillet 230a configured to nest in an internal fillet formed at the juncture between the first axial side 142 of the teeth 114 and the first outer cylindrical surface 122. The second end face 226a can be on an axially opposite side of the base 210a from the first end face 222a, such that the second end face 226a can face axially away from the teeth 114. In the example provided, the first and second end faces 222a, 226a can be perpendicular to the axis 118, though other configurations can be used.

The projections 214a can be fixedly coupled to the base 210a radially outward of the inner cylindrical surface 218a and can be equally spaced circumferentially about the base 210a. The projections 214a can extend radially outward from the base 210a. Each projection 214a can have a top surface 234a, a first end face 238a, a second end face 242a, a first side face 246a, and a second side face 250a. The top surface 234a can be a radially outermost surface of the first sprocket cushion 18a when the projections 214a are in a relaxed state (e.g., not compressed radially inward), as shown in FIGS. 2-4. The top surface 234a can be a generally flat surface or can be a cylindrical surface coaxial with the axis 118. In the example provided, the top surface 234a can be disposed radially inward of the valleys 134 of the teeth 114 and can have a constant radial distance from the axis 118 when in an uncompressed state. The first end face 238a of each projection 214a can be flush with the first end face 222a of the base 210a and can extend radially outward therefrom. In the example provided, the first end face 238a of the projections 214a can oppose and contact the first axial side 142 of the teeth 114.

The second end face 242a of the projections 214a can have a chamfer 254a that extends at an angle 258a relative to the top surface 234a and an angle relative to the second end face 226a of the base 210a to connect the top surface 234a and the second end face 226a of the base 210a. In the example provided, a first exterior fillet 262a having a first radius tangently connects the chamfer 254a to the second end face 226a of the base 210a and a second exterior fillet 266a having a second radius tangently connects the chamfer 254a to the top surface 234a. The chamfer 254a can be a generally flat surface extending between the second end face 226a of the base 210a and the top surface 234a, or can be slightly frusto-conical and disposed coaxially about the axis 118. In some configurations, the angle 258a can be between 15 degrees and 75 degrees. In the example provided, the angle 258a can be approximately 60 degrees, though other configurations can be used. Thus, the radial thickness of each projection 214a can decrease with increased axial distance away from the teeth 114.

The first side face 246a of each projection 214a can generally face toward the second side face 250a of a circumferentially adjacent one of the projections 214a. Each first side face 246a can extend radially inward from the corresponding top surface 234a in a curved manner to join with the second side face 250a of a corresponding adjacent one of the projections 214a, thus forming a valley 270a where the first and second side faces 246a, 250a meet. In the example provided, the first and second side faces 246a, 250a can have a curved profile such that the first and second side faces 246a, 250a start tangent to the top surface 234a, then transition from a convex region to a concave region at a valley transition region or transition line 274a. In the example provided, the valleys 270a of the first sprocket cushion 18a can generally align in the circumferential direction with the valleys 134 of the teeth 114, though other configurations can be used. In alternative configurations, not specifically shown, the valleys 270a of the first sprocket cushion 18a can align in the circumferential direction with the peaks 130, or can be aligned in the circumferential direction between the peaks 130 and the valleys 134 of the teeth 114. Returning to the example provided, the chamfer 254a can extend radially inward of the valley transition line 274a. In the example provided, the chamfer 254a can extend radially inward of the radially inwardmost point of the valley 270a such that the chamfer 254a forms one entire edge of the first and second side faces 246a, 250a. In other words, the first exterior fillet 262a can be disposed radially inward of the valley 270a.

The second sprocket cushion 18b can be similar to the first sprocket cushion 18a except that the second sprocket cushion 18b can be coupled to the hub 110 on the second axial side 146 of the teeth 114. Thus, the second sprocket cushion 18b can include an annular base 210b and a plurality of projections 214b. In the example provided, the base 210b and the plurality of projections 214b are integrally formed from a resilient material, such as being a unitarily molded rubber or other elastomeric body. The base 210b can be disposed about the axis 118 and coupled to the hub 110 on the second axial side 146 of the teeth 114.

The base 210b can have an inner cylindrical surface 218b, a first end face 222b, and a second end face 226b. The inner cylindrical surface 218b can be coaxial with the axis 118 and can oppose and contact the second outer cylindrical surface 126 of the hub 110. The diameter of the inner cylindrical surface 218b can be less than or equal to the diameter of the second outer cylindrical surface 126, such that the second sprocket cushion 18b can be retained to the hub 110 by the radial resilience of the annular base 210b. The first and second end faces 222b, 226b can be generally transverse to the axis 118 and extend radially outward from the inner cylindrical surface 218b. The first end face 222b can oppose and contact the second axial side 146 of the teeth 114. In the example provided, the juncture between the inner cylindrical surface 218b and the first end face 222b can include an exterior fillet 230b configured to nest in an internal fillet formed at the juncture between the second axial side 146 of the teeth 114 and the second outer cylindrical surface 126. The second end face 226b can be on an axially opposite side of the base 210b from the first end face 222b, such that the second end face 226b can face axially away from the teeth 114. In the example provided, the first and second end faces 222b, 226b can be perpendicular to the axis 118, though other configurations can be used.

The projections 214b can be fixedly coupled to the base 210b radially outward of the inner cylindrical surface 218b and can be equally spaced circumferentially about the base 210b. The projections 214b can extend radially outward from the base 210b. Each projection 214b can have a top surface 234b, a first end face 238b, a second end face 242b, a first side face 246b, and a second side face 250b. The top surface 234b can be a radially outermost surface of the second sprocket cushion 18b when the projections 214b are in a relaxed state (e.g., not compressed radially inward). The top surface 234b can be a generally flat surface or can be a cylindrical surface coaxial with the axis 118. In the example provided, the top surface 234b can be disposed radially inward of the valleys 134 of the teeth 114 and can have a constant radial distance from the axis 118 when in an uncompressed state. The first end face 238b of each projection 214b can be flush with the first end face 222b of the base 210b and can extend radially outward therefrom. In the example provided, the first end face 238b of the projections 214b can oppose and contact the second axial side 146 of the teeth 114.

The second end face 242b of the projections 214b can have a chamfer 254b that extends at an angle 258b relative to the top surface 234b and an angle relative to the second end face 226b of the base 210b to connect the top surface 234b and the second end face 226b of the base 210b. In the example provided, a first exterior fillet 262b having a first radius tangently connects the chamfer 254b to the second end face 226b of the base 210b and a second exterior fillet 266b having a second radius tangently connects the chamfer 254b to the top surface 234b. The chamfer 254b can be a generally flat surface extending between the second end face 226b of the base 210b and the top surface 234b, or can be slightly frusto-conical and disposed coaxially about the axis 118. In some configurations, the angle 258a can be between 15 degrees and 75 degrees. In the example provided, the angle 258b can be approximately 60 degrees, though other configurations can be used. Thus, the radial thickness of each projection 214b can decrease with increased axial distance away from the teeth 114.

The first side face 246b of each projection 214b can generally face toward the second side face 250b of a circumferentially adjacent one of the projections 214b. Each first side face 246b can extend radially inward from the corresponding top surface 234b in a curved manner to join with the second side face 250b of a corresponding adjacent one of the projections 214b, thus forming a valley 270b where the first and second side faces 246b, 250b meet. In the example provided, the first and second side faces 246b, 250b can have a curved profile such that the first and second side faces 246b, 250b start tangent to the top surface 234b, then transition from a convex region to a concave region at a valley transition region or transition line 274b. In the example provided, the valleys 270b of the second sprocket cushion 18b can generally align in the circumferential direction with the valleys 134 of the teeth 114, though other configurations can be used. In alternative configurations, not specifically shown, the valleys 270b of the first sprocket cushion 18b can align in the circumferential direction with the peaks 130, or can be aligned in the circumferential direction between the peaks 130 and the valleys 134 of the teeth 114. Returning to the example provided, the chamfer 254b can extend radially inward of the valley transition line 274b. In the example provided, the chamfer 254b can extend radially inward of the radially inwardmost point of the valley 270b such that the chamfer 254b forms one entire edge of the first and second side faces 246b, 250b. In other words, the first exterior fillet 262b can be disposed radially inward of the valley 270b.

While not specifically shown, the second sprocket can be similar to the first sprocket wheel 14. The additional sprocket cushions (not shown), similar to the first and second sprocket cushions 18a, 18b and can be coupled to the second sprocket wheel (not shown) in a similar manner as described above.

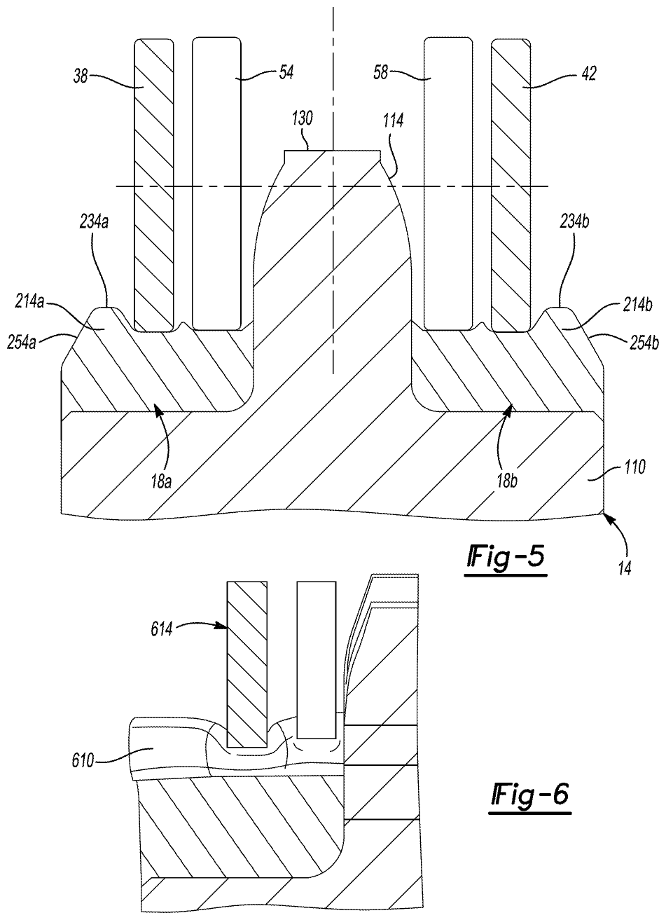

With additional reference to FIG. 5, a sectional view of a portion of the first sprocket wheel 14 showing the first and second sprocket cushions 18a, 18b in a compressed state (i.e., compressed by the chain 26) is illustrated. As shown in FIG. 5, one of the second side plates 54 can be disposed on the first axial side 142 of the teeth 114 and the other of the second side plates 58 can be disposed on the second axial side 146 of the teeth 114. The first side plates 38, 42 can be axially outward of the second side plates 54, 58 relative to the teeth 114 and axially inward of the chamfers 254a, 254b. When the chain 26 is engaged with the first sprocket wheel 14, the first and second side plates 38, 42, 54, 58 can contact the top surfaces 234a, 234b of the first and second sprocket cushions 18a, 18b and compress the projection 214a, 214b radially inward.

With additional reference to FIG. 6, a sectional view similar to FIG. 5 is illustrated showing compression of a typical sprocket cushion 610 by a chain 614. In comparison to the first and second sprocket cushions 18a, 18b shown in FIG. 5, the compression of the typical sprocket cushion 610 by the chain 614 causes large displacement of the cushion material and results in greater levels of internal stresses and strain within the cushion material. Such internal stress and strain in the typical sprocket cushion 610 can diminish the performance and longevity of the typical sprocket cushion 610 compared to the first and second sprocket cushions 18a, 18b of FIGS. 1-5. The reduction in material at the axially outermost and radially outermost areas of the first and second sprocket cushions 18a, 18b (e.g., the chamfers 254a, 254b, axially outward of where the chain 26 engages the first and second sprocket cushions 18a, 18b), unexpectedly reduces the internal stresses and strains of the cushion material during repeated loading and unloading (i.e., compression and decompression). Furthermore, the angled face of the chamfer 254b unexpectedly provides for better compression by lowering internal stress and strain.

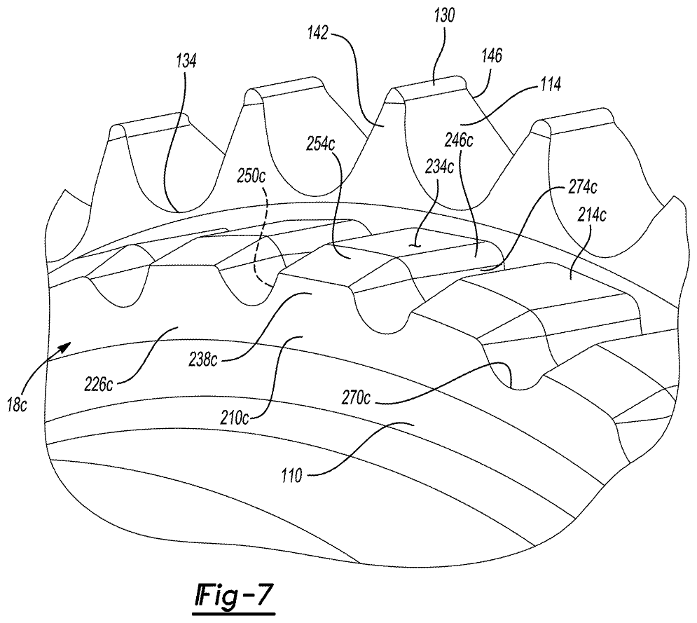

With additional reference to FIG. 7, a sprocket cushion 18c of a different configuration is illustrated. The sprocket cushion 18c can be similar to the sprocket cushions 18a, or 18b, except as otherwise shown or described herein. Accordingly, similar features are denoted with similar reference numerals, with the suffix “c”, and only the differences will be described in detail herein. In the example provided, the chamfer 254c of the sprocket cushion 18c does not extend radially inward of the valley 270c. In other words, the chamfer 254c extends between the top surface 234c and the second end face 242c and connects to the second end face 242c at a location radially outward of the radially innermost point of the valley 270c. In the example provided, the chamfer 254c can join the second end face 242c at a location radially between the top surface 234c and the valley transition line 274c. In an alternative configuration, the chamfer 254c can join the second end face 242c at the valley transition line 274c, or a location radially between valley transition line 274c and the radially innermost point of the valley 270c.

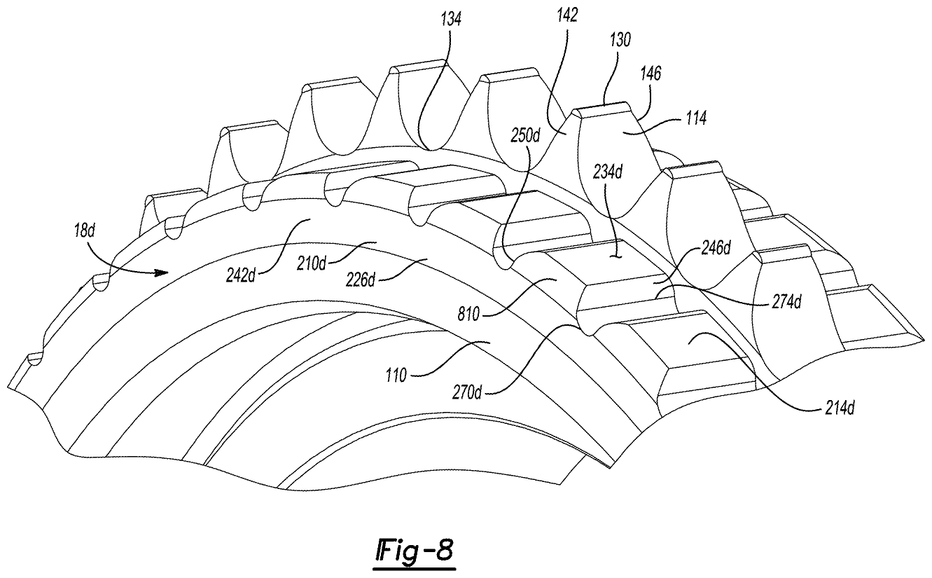

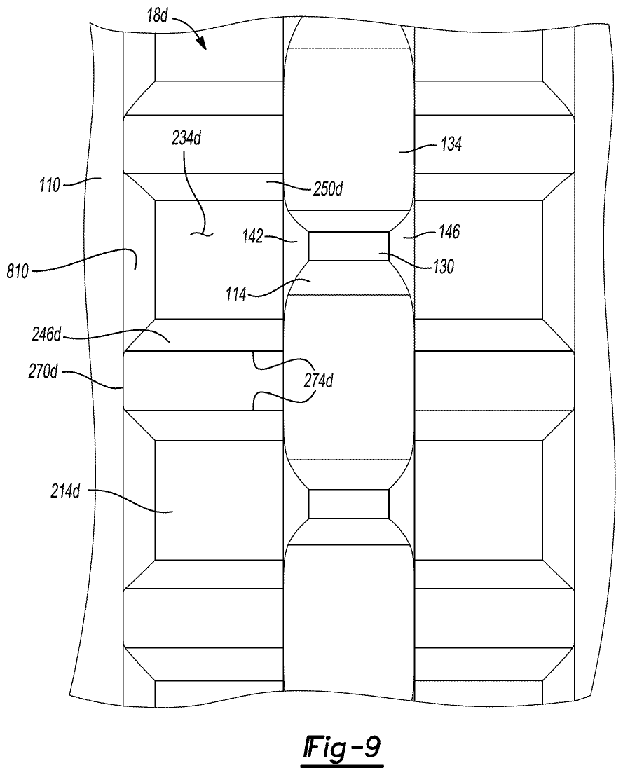

With additional reference to FIGS. 8 and 9, a sprocket cushion 18d of a different configuration is illustrated. The sprocket cushion 18d can be similar to the sprocket cushions 18a, 18b, or 18c, except as otherwise shown or described herein. Accordingly, similar features are denoted with similar reference numerals, with the suffix “c”, and only the differences will be described in detail herein. In the example provided, the sprocket cushion 18d does not include the chamfer 254a, 254b, or 254c. Instead, a single, large radius fillet 810 can tangently join the top surface 234d to the second end face 242d. The large radius fillet 810 can have a radius such that the large radius fillet 810 tangently joins the second end face 242d at a location that is radially at or inward (relative to the axis 118) of the valley transition line 274d. In the example provided, the large radius fillet 810 tangently joins the second end face 242d at a location that is radially between the valley transition line 274d and the radially inwardmost point of the valley 270d. In an alternative configuration, the large radius fillet 810 can tangently join the second end face 242d at a location that is radially inward of the radially inwardmost point of the valley 270d. In the example provided, the location at which the large radius fillet 810 meets the second end face 242d can be radially inward of approximately half way between the top surface 234d and the radially inwardmost point of the valley 270d. In the example provided, the fillet (810) has a constant radius of curvature, though in an alternative configuration, the fillet (810) can have a radius of curvature that can vary between second end face 242d and the top surface 234d.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “top,” “bottom,” “left,” “right,” “front,” “back”, “forward,” “behind,” “beneath,” “below,” “lower,” “above,” “over,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

What is claimed is:

1. A sprocket assembly (10) comprising:
a sprocket wheel (14) including a hub (110) disposed about an axis (118) and a plurality of teeth (114) extending radially outward from the hub (110);
a first sprocket cushion (18a, 18b, 18c) coupled to the hub (110) on a first axial side (142) of the teeth (114), the first sprocket cushion (18a, 18b, 18c) including an annular base (210a, 210b, 210c) and a plurality of projections (214a, 214b, 214c), the base (210a, 210b, 210c) being disposed about the hub (110), the projections (214a, 214b, 214c) extending radially outward from the base (210a, 210b, 210c), each projection (214a, 214b, 214c) including a first axial end (238a, 238b, 238c), a second axial end (242a, 242b, 242c), a top surface (234a, 234b, 234c), and a chamfer (254a, 254b, 254c), the first axial end (238a, 238b, 238c) being proximal to the first axial side (142) of the teeth (114), the top surface (234a, 234b, 234c) extending axially between the first axial end (238a, 238b, 238c) and the second axial end (242a, 242b, 242c), the chamfer (254a, 254b, 254c) joining the second axial end (242a, 242b, 242c) and the top surface (234a, 234b, 234c) such that a radial thickness of each projection (214a, 214b, 214c) decreases with increased axial distance away from the teeth (114).

2. The sprocket assembly (10) of claim 1, wherein a first fillet (266a, 266b) tangently connects the top surface (234a, 234b) and the chamfer (254a, 254b).

3. The sprocket assembly (10) of claim 2, wherein a second fillet (262a, 262b) tangently connects the chamfer (254a, 254b) and a first end face (226a, 226b) of the base (210a, 210b).

4. The sprocket assembly (10) of claim 3, wherein the first end face (226a, 226b) of the base (210a, 210b) is perpendicular to the axis (118).

5. The sprocket assembly (10) of claim 1, wherein each projection (214a, 214b) is circumferentially spaced apart from an adjacent one of the projections (214a, 214b) by a corresponding one of a plurality of valleys (270a, 270b), each chamfer (254a, 254b) extending radially inward of a radially inwardmost point of the corresponding one of the valleys (270a, 270b).

6. The sprocket assembly (10) of claim 1, wherein each projection (214c) is circumferentially spaced apart from an adjacent one of the projections (214c) by a corresponding one of a plurality of valleys (270c), each valley (270c) extending radially inward of a radially inwardmost point of a corresponding one of the chamfers (254c).

7. The sprocket assembly (10) of claim 1, wherein each projection (214a, 214b) is circumferentially spaced apart from an adjacent one of the projections (214a, 214b) by a corresponding one of a plurality of valleys (270a, 270b), each valley (270a, 270b) having a convex portion and a concave portion that meet at a transition region (274a, 274b), the chamfer (254a, 254b) extending radially inward of the transition region (274a, 274b).

8. The sprocket assembly (10) of claim 1, further comprising a second sprocket cushion (18a, 18b, 18c) coupled to the hub (110) on a second axial side (146) of the teeth (114).

9. The sprocket assembly (10) of claim 1, wherein each tooth (114) is circumferentially spaced apart from an adjacent one of the teeth (114) by a corresponding one of a plurality of tooth valleys (134), and each projection (214a, 214b, 214c) is circumferentially spaced apart from an adjacent one of the projections (214a, 214b, 214c) by a corresponding one of a plurality of cushion valleys (270a, 270b, 270c), each cushion valley (270a, 270b, 270c) aligning with one of the tooth valleys (134).

10. The sprocket assembly (10) of claim 1, wherein the chamfer (254a, 254b, 254c) defines an angle (258a, 258b) relative to the axis (118), the angle (258a, 258b) being between 15 degrees and 75 degrees.

11. A sprocket assembly (10) comprising:
a sprocket wheel (14) including a hub (110) disposed about an axis (118) and a plurality of teeth (114) extending radially outward from the hub (110);
a first sprocket cushion (18d) coupled to the hub (110) on a first axial side (142) of the teeth (114), the first sprocket cushion (18d) including an annular base (210d) and a plurality of projections (214d), the base (210d) being disposed about the hub (110), the projections (214d) extending radially outward from the base (210d), each projection (214d) including a first axial end (238d), a second axial end (242d), a top surface (234d), and a fillet (810), the first axial end (238d) being proximal to the first axial side (142) of the teeth (114), the top surface (234d) extending axially between the first axial end (238d) and the second axial end (242d), the fillet (810) joining the second axial end (242d) and the top surface (234d), wherein each projection (214d) is circumferentially spaced apart from an adjacent one of the projections (214d) by a corresponding one of a plurality of valleys (270d), and wherein the fillet (810) meets the second axial end (242d) radially inward of half way between the top surface (234d) and a radially inwardmost point of the valley (270d).

12. The sprocket assembly (10) of claim 11, wherein each valley (270d) has a convex portion and a concave portion that meet at a transition region (274d), and the fillet (810) meets the second axial end (242d) radially inward of the transition region (274d).

13. The sprocket assembly (10) of claim 11, wherein the fillet (810) tangently joins the top surface (234d) and the second axial end (242d).

14. The sprocket assembly (10) of claim 11, wherein the fillet (810) has a radius of curvature that varies between the top surface (234d) and the second axial end (242d).

15. A sprocket assembly (10) comprising:
a sprocket wheel (14) including a hub (110) disposed about an axis (118) and a plurality of teeth (114) extending radially outward from the hub (110);
a first sprocket cushion (18a) coupled to the hub (110) on a first axial side (142) of the teeth (114), the first sprocket cushion (18a) including an annular first base (210a, 210b, 210c) and a plurality of first projections (214a), the first base (210a, 210b, 210c) being disposed about the hub (110), the first projections (214a) extending radially outward from the first base (210a, 210b, 210c), each first projection (214a) including a first axial end (238a), a second axial end (242a), a first radially outermost surface (234a), and a first chamfer (254a), the first axial end (238a) being proximal to the first axial side (142) of the teeth (114), the first radially outermost surface (234a) extending axially between the first axial end (238a) and the second axial end (242a), the first chamfer (254a) joining the second axial end (242a) and the first radially outermost surface (234a) such that a radial thickness of each first projection (214a) decreases in an axial direction away from the teeth (114);
a second sprocket cushion (18b) coupled to the hub (110) on a second axial side (142) of the teeth (114), the second sprocket cushion (18b) including an annular second base (210a, 210b, 210c) and a plurality of second projections (214b), the second base (210a, 210b, 210c) being disposed about the hub (110), the second projections (214b) extending radially outward from the second base (210a, 210b, 210c), each second projection (214b) including a third axial end (238b), a fourth axial end (242b), a second radially outermost surface (234b), and a second chamfer (254b), the third axial end (238b) being proximal to the second axial side (142) of the teeth (114), the second radially outermost surface (234b) extending axially between the third axial end (238b) and the fourth axial end (242b), the second chamfer (254b) joining the fourth axial end (242b) and the second radially outermost surface (234b) such that a radial thickness of each second projection (214b) decreases in an axial direction away from the teeth (114);
wherein a first fillet (266a) tangently joins the first radially outermost surface (234a) and the first chamfer (254a) and a second fillet (262a) tangently joins the first chamfer (254a) and the second axial end (242a), each first projection (214a) being circumferentially spaced apart from an adjacent one of the first projections (214a) by a corresponding one of a plurality of first valleys (270a), each first chamfer (254a) extending radially inward of a radially inwardmost point of the first valleys (270a);
wherein a third fillet (266b) tangently joins the second radially outermost surface (234b) and the second chamfer (254b) and a fourth fillet (262b) tangently joins the second chamfer (254b) and the fourth axial end (242b), each second projection (214b) is circumferentially spaced apart from an adjacent one of the second projections (214b) by a corresponding one of a plurality of second valleys (270b), each second chamfer (254b) extending radially inward of a radially inwardmost point of the second valleys (270b).
